(19) United States
(12) Patent Application Publication
(10) Pub. No.: US 2017/0288902 A1
(43) Pub. Date: Oct. 5, 2017

(54) Method and Apparatus for Detecting Data in Wireless Communication Networks

(71) Applicant: Huawei Technologies Co., Ltd., Shenzhen (CN)

(72) Inventors: Fredrik Rusek, Lund (SE); Sha Hu, Shenzhen (CN)

(21) Appl. No.: 15/629,181

(22) Filed: Jun. 21, 2017

Related U.S. Application Data
(63) Continuation of application No. PCT/EP2015/052743, filed on Feb. 10, 2015.

(51) Int. Cl. H04L 25/03; H04L 27/34; H04B 17/336; H04L 1/00; H04M 1/725; H04W 76/04

(52) U.S. Cl. CPC H04L 12/46; H04L 25/03968; H04M 1/72519; H04W 76/045; H04B 17/336; H04L 1/0042; H04L 27/3461

(57) ABSTRACT

An apparatus including a processor configured to receive a digital communication signal having a plurality of transmitted layers. The processor is configured to determine an estimated channel matrix based on the digital communication signal, determine a first estimated transmitted symbol vector and a mean square error matrix based on a linear analysis of the received digital communication signal. A first set of bit LLR are determined based on a LMMSE type detector and a second set of bit LLR are determined based on a novel simplified tree search process. The two sets of bit LLR are then combined and used to detect the data in the received communication signal. The simplified tree search process uses a specially formed channel shortening process to determine a set of shortened channel correlation matrices that allow the second set of bit LLR to be determined using an alternative marginalized tree search process.

### CROSS-REFERENCE TO RELATED APPLICATIONS

This application is a continuation of International Application No. PCT/EP2015/052743, filed on Feb. 10, 2015, the disclosure of which is hereby incorporated by reference in its entirety.

### TECHNICAL FIELD

The aspects of the present disclosure relate generally to wireless communication systems and in particular to data detection in a wireless communications link.

### BACKGROUND

The proliferation of modern wireless communications devices, such as cell phones, smart phones, and tablet devices, has seen an attendant rise in demand for high volume multimedia data capabilities for large populations of user equipment (UE) or mobile stations. These multimedia data capabilities may be used to provide services at the UE such as streaming radio, online gaming, music, and TV. To support this ever increasing demand for higher data rates, multiple-access networks are being deployed based on a variety of transmission techniques such as time division multiple access (TDMA), code division multiple access (CDMA), frequency division multiple access (FDMA), orthogonal frequency division multiple access (OFDMA), and single carrier FDMA (SC_FDMA). New standards for wireless networks are also being developed to provide ever increasing data rates. Examples of these newer standards include Long Term Evolution (LTE) and LTE-Advanced (LTE-A) being developed by the third generation partnership project (3GPP), the 802.11 and 802.16 family of wireless broadband standards maintained by the Institute of Electric and Electronic Engineers (IEEE), WiMAX, an implementation of the IEEE 802.11 standard from the WiMAX Forum, as well as others. Networks based on these standards provide multiple-access to support multiple simultaneous users by sharing available network resources.

Many of these newer standards support multiple antennas at both the base station and the UE. These multi-antenna configurations, referred to as multi-input multi-output (MIMO), provide improved spectral efficiency resulting in increased data rates. However the improved capacity comes at the cost of increased complexity and computational requirements at the transmitter and receiver. Detection of the transmitted data symbols at the receiver can be a difficult problem in systems with multiple transmit and receive antennas. Theoretically, maximum log likelihood detection (MLD) is the optimal method of detecting the transmitted data symbols. Unfortunately, the computational complexity of MLD in large MIMO systems often exceeds the computational capabilities of the UE preventing its use in low end UE. An alternative to MLD is a linear minimum mean square error (LMMSE) detector which has low computational complexity but suffers from sub-optimal performance especially when the condition number of the MIMO channel matrix is large. Another approach is the development of less complex maximum likelihood (ML) based methods, sometimes referred to as quasi-ML detection methods. The goal of these quasi-ML detection methods is to reduce the overall computational complexity while providing performance that is as close as possible to MLD.

A conventional method of approximating optimal MIMO detection is to reduce the size of the candidate set of symbol vectors that needs to be searched. The search size can be reduced by removing branches from the search tree, sometimes referred to as a pruning process, based on priority information obtained from a low complexity linear detector. Once the candidate set has been substantially reduced, a simplified or approximate ML detection can be implemented to refine the search results.

Another conventional approach, often referred to as the QR-M algorithm, applies QR decomposition to the channel matrix then reduces the size of the tree search by retaining only the best candidate nodes. Another variant of the QR-M algorithm is known as the K-Best algorithm which employs detection similar to the vertical-Bell Labs Space Time (V-BLAST) structure. With these approaches, only a limited number of candidates are retained at each layer, and because the limited number is usually much smaller than the full possible set, the complexity is also reduced.

These approaches can significantly reduce the complexity as compared to MLD. However, in order to achieve near MLD performance the complexity is still too high for implementation in many UE designs. This is especially true in advanced communication systems, such as LTE, or LTE-A, where large systems including 4×4 or 8×8 MIMO are applied with high order modulation schemes such as 64 symbol quadrature amplitude modulation (64QAM) or 256 symbol QAM (256QAM). The complexity of detectors in these systems increases exponentially with the number of MIMO layers and the high order modulation schemes.

Thus there is a need for improved methods and apparatus for detecting symbols in advanced communication networks.

### SUMMARY

It is an object of the present disclosure to provide an apparatus and methods to detect data in a wireless communication signal. A further object of the present disclosure is to provide methods and apparatus that can achieve near optimal data detection performance with significantly reduced computational complexity. Reducing computational complexity allows low cost UE to achieve significant improvements in data transmission rates.

According to a first aspect of the present disclosure the above and further objects and advantages are obtained by an apparatus for receiving wireless communication signals that includes a processor configured to receive a digital communication signal, where the digital communication signal has a plurality of transmitted layers. The processor is configured to determine an estimated channel matrix based on the digital communication signal. The processor then determines a first estimated transmitted symbol vector and a mean square error matrix based on a linear analysis of the received digital communication signal and determines a first set of bit log likelihood ratios by performing linear minimum mean square error detection based on the first estimated transmitted symbol vector. The processor is also configured to determine a second set of bit log likelihood ratios by performing a tree search for one or more layers in the plurality of transmitted layers in the digital communication signal, based on the first estimated transmitted symbol vector and the mean square error matrix. The processor is configured to determine a refined set of bit log likelihood ratios based on the first set of bit log likelihood ratios and the second set of bit log likelihood ratios, and to determine a second estimated transmitted symbol vector based on the refined set of bit log likelihood ratios. The processor determines the second set of bit log likelihood ratios by selecting a set of parent layers from the plurality of transmitted layers, wherein the number of layers in the set of parent layers is less than or equal to the number of layers in the plurality of transmitted layers. A shortened channel correlation matrix is then determined for each layer in the set of parent layers, based on the mean square error matrix. An optimal shortened channel matrix is determined based on each shortened channel correlation matrix and the estimated channel matrix. During each tree search a single child node is selected for each parent node in the tree search based on evaluation of a branch metric, and the second set of bit log likelihood ratios is determined based on the results of each tree search.

In a first possible implementation form of the apparatus according to the first aspect, improved data transmission rates are achieved with reduced computational complexity by configuring the processor to determine the first set of bit log likelihood ratios based on a detector comprising one or more of a linear minimum mean square error detector, successive interference cancellation, and parallel interference cancellation.

In a second possible implementation form of the apparatus according to the first aspect as such or to the first possible implementation form of the first aspect, improved data transmission rates are achieved with reduced computational complexity by configuring the processor to evaluate the branch metric based on the shortened channel correlation matrix and a single parent node.

In a third possible implementation form of the apparatus according to the first aspect as such or to the first or second possible implementation forms of the first aspect, improved data transmission rates are achieved with reduced computational complexity by configuring the processor to select the single child node as the node having a maximum value of the branch metric.

In a fourth possible implementation form of the apparatus according to the first aspect as such or to the first through third possible implementation forms of the first aspect, processing time is reduced by configuring the processor to perform the tree search for each parent layer in the set of parent layers in parallel.

In a fifth possible implementation form of the apparatus according to the first aspect as such or to the first through fourth possible implementation forms of the first aspect, improved data transmission rates are achieved with reduced computational complexity by configuring the processor to select when the corresponding element of the shortened channel correlation matrix is positive the child node having a peak value of the branch metric, and when the corresponding element of the shortened channel correlation matrix is negative select the child node based on a quadrant of a residual value.

In a sixth possible implementation form of the apparatus according to the first aspect as such or to the first through fifth possible implementation forms of the first aspect, improved data transmission rates are achieved with reduced computational complexity when the number of parent layers is smaller than the number of transmitted layers by configuring the processor to select the layers in the set of parent layers based on an amount of energy or a channel capacity of the plurality of transmitted layers.

In a seventh possible implementation form of the apparatus according to the first aspect as such or to the first through sixth possible implementation forms of the first aspect, improved data transmission rates are achieved with reduced computational complexity by configuring the processor to determine the refined set of bit log likelihood ratios when the second set of bit log likelihood ratios is missing a bit hypothesis by determining the sign of the bit log likelihood ratio corresponding to the missing bit hypothesis and determining the refined set of bit log likelihood ratios based on the determined sign and the first set of log likelihood ratios.

In an eighth possible implementation form of the apparatus according to the first aspect as such or to the first through seventh possible implementation forms of the first aspect, improved data transmission rates are achieved with reduced computational complexity by configuring the processor to determine the shortened channel correlation matrix based on a mismatched received signal probability density function.

In a ninth possible implementation form of the apparatus according to the first aspect as such or to the first through eighth possible implementation forms of the first aspect, improved data transmission rates are achieved with reduced computational complexity by configuring the processor to determine the shortened channel correlation matrix based on a factorization matrix. The factorization matrix has non-zero elements on its main diagonal, non-zero elements in its last column, and the remaining elements of the factorization matrix have a zero value.

In a tenth possible implementation form of the apparatus according to the first aspect as such or to the first through ninth possible implementation forms of the first aspect, improved data transmission rates are achieved with reduced computational complexity by configuring the processor to use a permutation matrix to switch a layer in the set of parent layers to be a parent layer for the tree search. The elements of the permutation matrix have a value of zero or one, pre or post multiplication of the permutation matrix by a transpose of the permutation matrix yields an identity matrix, and the permutation matrix is configured to switch a layer in the set of parent layers to be the parent layer for the corresponding tree search and to leave the remaining layers unchanged.

In an eleventh possible implementation form of the apparatus according to the first aspect as such or to the first through tenth possible implementation forms of the first aspect, improved data transmission rates are achieved with reduced computational complexity by configuring the processor to select the set of parent layers based on an amount of energy or a channel capacity of each layer in the plurality of transmitted layers.

In a twelfth possible implementation form of the apparatus according to the first aspect as such or to the first through eleventh possible implementation forms of the first aspect, improved data transmission rates are achieved with reduced computational complexity by configuring the processor to determine the shortened channel correlation matrix for a second layer in the set of parent layers based on computation results obtained from determining the shortened channel correlation matrix for a first layer in the set of parent layers.

According to a second aspect of the present disclosure the above and further objects and advantages are obtained by a method for detecting data in a wireless communication system. The method includes receiving a digital communication signal, where the digital communication signal has a plurality of transmitted layers. An estimated channel matrix is determined based on the digital communication signal and a first estimated transmitted symbol vector and a mean square error matrix are determined based on a linear analysis of the received digital communication signal. A first set of bit log likelihood ratios is determined by performing linear minimum mean square error detection based on the first estimated transmitted symbol vector, and a second set of bit log likelihood ratios is determined by performing a tree search for one or more layers in the plurality of transmitted layers in the digital communication signal, based on the first estimated transmitted symbol vector and the mean square error matrix. A refined set of bit log likelihood ratios is determined from the first set of bit log likelihood ratios and the second set of bit log likelihood ratios, and a second estimated transmitted symbol vector is determined based on the refined set of bit log likelihood ratios. Determination of the second set of bit log likelihood ratios is accomplished by selecting a set of parent layers from the plurality of transmitted layers, wherein a number of layers in the set of parent layers is less than or equal to a number of layers in the plurality of transmitted layers. A shortened channel correlation matrix is then determined for each layer in the set of parent layers, based on the mean square error matrix and an optimal shortened channel matrix is determined based on each determined shortened channel correlation matrix and the estimated channel matrix. A single child node is selected for each parent node in the tree search based on evaluation of a branch metric, and the second set of bit log likelihood ratios is determined based on the tree search.

According to a third aspect of the present disclosure the above and further objects and advantages are obtained by a computer program including non-transitory computer program instructions that when executed by a processor cause the processor to perform the method according to the second aspect as such or to the first possible implementation form of the second aspect.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed disclosure, for which reference should be made to the appended claims. Additional aspects and advantages of the disclosure will be set forth in the description that follows, and in part will be obvious from the description, or may be learned by practice of the disclosure. Moreover, the aspects and advantages of the disclosure may be realized and obtained by means of the instrumentalities and combinations particularly pointed out in the appended claims.

### BRIEF DESCRIPTION OF THE DRAWINGS

In the following detailed portion of the present disclosure, embodiment of the disclosure will be explained in more detail with reference to the example embodiments shown in the drawings, in which:

FIG. 1 illustrates a tree diagram depicting a maximum likelihood type detector incorporating aspects of the disclosed embodiments;

FIG. 2 illustrates a tree diagram depicting a reduced complexity detector incorporating aspects of the disclosed embodiments;

FIG. 3 illustrates a tree diagram for an alternative marginalized tree search incorporating aspects of the disclosed embodiments;

FIG. 4 illustrates a constellation mapping diagram incorporating aspects of the present disclosure;

FIG. 5 illustrates a block diagram of an alternative marginalized tree search (AMTS) detector incorporating aspects of the disclosed embodiments;

FIG. 6 illustrates a flow chart of an AMTS process incorporating aspects of the disclosed embodiments;

FIG. 7 illustrates a graph of normalized throughput incorporating aspects of the present disclosure;

FIG. 8 illustrates a block diagram of a mobile device incorporating aspects of the disclosed embodiments.

### DETAILED DESCRIPTION OF THE DISCLOSED EMBODIMENTS

In wireless receivers such as those used in UE employed as mobile devices, it is desirable to use detectors with low or reduced complexity to provide accurate symbol detection in lower cost UE. This goal can be achieved by using a technique employing a device according to an embodiment of the present disclosure which is configured to receive a digital communication signal that includes a plurality of layers. A channel matrix is estimated based on the digital communication signal and a first estimated transmitted symbol vector and mean square error vector is determined based on a linear analysis of the received digital communication signal. A first set of bit log likelihood ratios is determined using a linear minimum mean square error type detector based on the first estimated symbol vector and the mean square error matrix, and a second set of bit log likelihood ratios is determined by performing a tree search for one or more of the transmitted layers based on the first estimated symbol vector and the mean square error matrix. A refined set of bit log likelihood ratios is determined based on both the first and second bit log likelihood ratios. A final estimated transmitted symbol vector is determined based on the refined set of bit log likelihood ratios.

A second set of bit log likelihood ratios is determined using a tree search that begins by selecting a set of parent layers from the set of transmitted layers. The set of selected parent layers may include all of the transmitted layers or a subset of the transmitted layers. A special shortened channel correlation matrix is determined for each of the selected parent layers and an optimal shortened channel matrix is determined from each shortened channel correlation matrix. A tree search is performed for each layer in the set of parent layers where each tree search is performed by selecting a single child node for each parent node based on evaluation of a branch metric and the second set of bit log likelihood ratios is determined based on the tree search.

As an aid to understanding the reduced complexity detector according to an embodiment described above, begin with a conventional model for the received signal in a wireless MIMO communication system as shown in Equation 1:

Y=hx+W. Eq. 1

The model of Equation 1 represents a MIMO system where the number of receive antennas is represented by an integer M and the number of transmit antennas is represented by an integer N. The transmitted signal X is a N×1 column vector, X (x₁,x₂, . . . x_{N})^{T}, where xᵢ(1≦i≦N) represents the symbol transmitted on the i^{th} antenna. The received signal Y is an M×1 column vector: Y=(y₁,y₂, . . . ,y_{M})^{T}, where yᵢ (1≦i≦M) represents the symbol received on the i^{th} antenna. The MIMO channel matrix H is an M×N matrix made up of N column vectors: H=(h₁,h₂, . . . ,h_{N}), where hᵢ(1≦i≦N) represents the i^{th} column vector in the channel matrix H. Thermal noise is represented in the system model illustrated in Equation 1 as a column vector W=(w₁,w₂, . . . w_{N})^{T} with dimension M×1.

The bit log likelihood ratio (bit LLR) may be calculated as shown in Equation 2:

$$L ( {b}_{k} ) = log ( \frac{{\sum }_{x ∈ {𝒮}_{{b}_{k} = 1}} p ( X \vert Y , H )}{{\sum }_{x ∈ {𝒮}_{{b}_{k} = 0}} p ( s \vert Y , H )} ) = log ( \frac{{\sum }_{x ∈ {𝒮}_{{b}_{k} = 1}} p ( Y \vert X , H ) p ( X )}{{\sum }_{x ∈ {𝒮}_{{b}_{k} = 0}} p ( Y \vert s , H ) p ( X )} ) {\approx }_{Jacobian approximation} {max}_{\begin{matrix}⏟ \\ x ∈ {𝒮}_{{b}_{k} = 1}\end{matrix}} \{ p ( Y \vert X , H ) p ( X ) \} - {max}_{\begin{matrix}⏟ \\ x ∈ {𝒮}_{{b}_{k} = 0}\end{matrix}} \{ p ( Y \vert X , H ) p ( X ) \} , {\approx }_{Uniform distribution of X} {max}_{\begin{matrix}⏟ \\ x ∈ {𝒮}_{{b}_{k} = 1}\end{matrix}} \{ p ( Y \vert X , H ) \} - {max}_{\begin{matrix}⏟ \\ x ∈ {𝒮}_{{b}_{k} = 0}\end{matrix}} \{ p ( Y \vert X , H ) \} \qquad Eq . 2$$

where S_{b}_{ₖ}₋₁ is the set of all possible transmitted symbol vectors with the k^{th} bit bₖ=1, and S_{b}_{ₖ}₋₀ is the set of all possible transmitted symbol vectors with the k^{th} bit bₖ=0. The posterior probability of the transmitted signal Xafter observing both the channel H and the received signal Y is represented as: p(X|Y, H) and the a priori probability with channel H and transmitted symbol vector X is represented as: p(Y|X, H). The a priori probability of transmitted signal X, p(X), is assumed to be equally distributed. A Jacobian approximation may be used to reduce the complexity by replacing the logarithm of the sum of probability terms:

$$log ( {\sum }_{x ∈ {𝒮}_{{b}_{k} = 1}} p ( Y \vert X , H ) p ( X ) ) ,$$

i=0,1, with the maximum of the probability terms:

$${max}_{\begin{matrix}⏟ \\ x ∈ {𝒮}_{{b}_{k} = 1}\end{matrix}} \{ p ( Y \vert X , H ) p ( X ) \} .$$

Even with the Jacobian approximation the complexity in large MIMO systems remains prohibitively high for implementation in many UE designs. For example in a MIMO system where there are 4 transmit antennas and the data is modulated using a 64 symbol alphabet such as with 64QAM, the set of symbol vectors with the kth bit equal to one, S_{b}_{ₖ}₌₁ and the set of symbol vectors with the kth bit equal to zero S_{b}_{ₖ}₌₀ each contain 64⁴/2=8388608 possible transmitted symbol vectors.

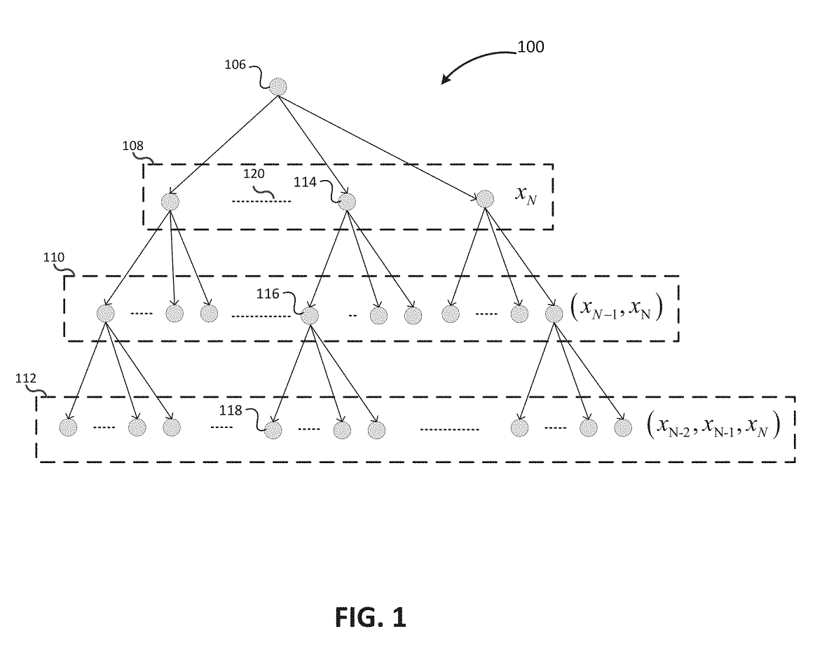

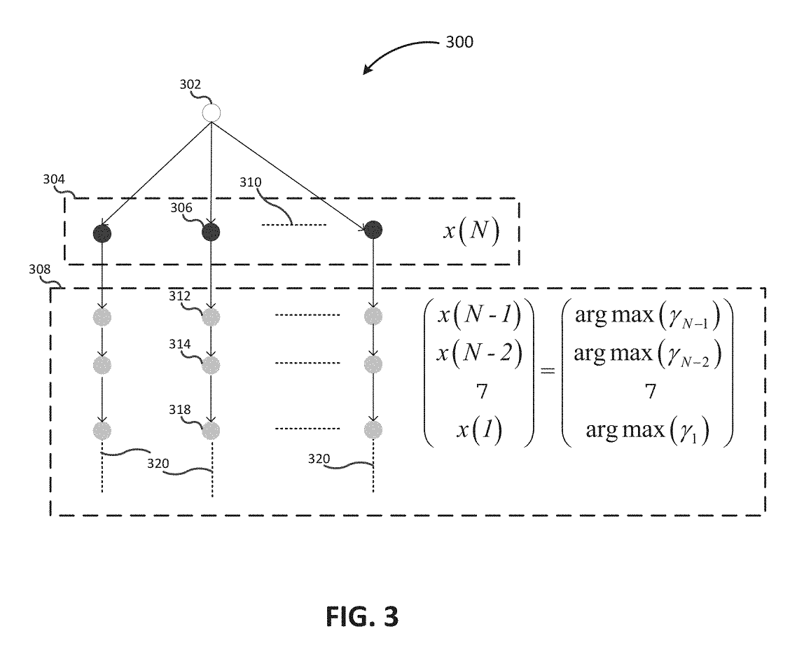

MLD methods may be formulated as tree search problems as illustrated by the search tree 100 depicted in FIG. 1. The search tree 100 includes a root node 106 representing a starting point for searching all possible transmitted symbol vectors X. Below the root node is a parent layer or set of parent nodes 108 where each parent node such as parent node 114 in the parent layer 108 represents a symbol in the transmitted symbol alphabet or codebook. The first level 108 includes a node for each symbol in the alphabet used for transmitting the first symbol x_{N}. For example when the first layer is transmitted using 64QAM there will be 64 nodes in the first layer 108. Below the parent layer 108, the search tree 100 includes a child layer 110, 112 corresponding to each additional layer in the transmitted signal. For example, when there are three (3) layers in the transmitted signal, the search tree 100 includes one parent layer 108 and two child layers 110, 112 as illustrated in FIG. 3. When there are four layers in the transmitted signal the search tree will have one parent layer and three child layers, etc. The first child layer 110 includes a node for each possible combination of symbols in the first two layers (x_{N-1},x_{N}).

For example when both the first 108 and second 110 layer are transmitted using 64QAM, the second level 110 will include 64² or 4096 nodes. For clarity, some of the nodes in each layer have been left out of the tree diagram 100 and replaced with dashed lines 120, where the dashed lines 120 are used to indicate a continuation of the adjacent pattern. In a full complexity design the MLD search pattern includes the entire tree 100. Each path from root node 106 to lowest level 112 child node represents a candidate path corresponding to a particular symbol vector (x_{N-2},x_{N-1},x_{N}). For example nodes 106, 114, 116, 118 represent a candidate path from the root node to the lowest level child node. In a full complexity MLD search all candidate paths are evaluated using a branch metric also referred to herein as a path metric to determine the best candidate path or symbol vector.

A number of conventional methods may be used to reduce the complexity of maximum likelihood symbol detection while keeping performance close to that of MLD. One conventional approach, often referred to as the QR-M algorithm, begins by performing QR decomposition on the channel matrix H=QR and transforming the received signal model as shown in Equation 3:

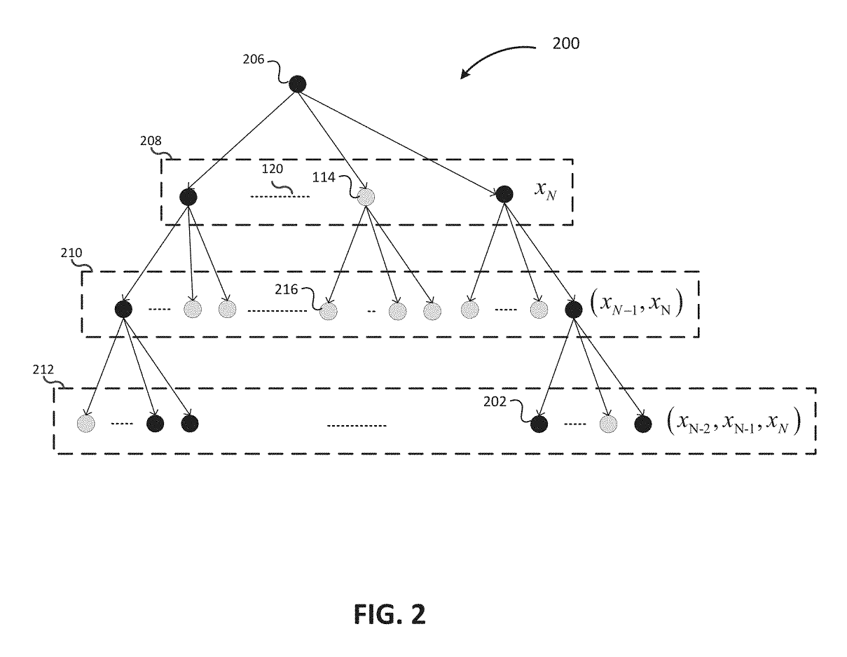

Z=RX+V. Eq. 3

where the transformed received symbol vector Z is formed from the Hermitian transpose of a matrix Q times the received symbol vector Y: Z=Q^{H}Y. The Hermitian transpose, also known as the conjugate transpose, is denoted by a superscript ^{H}. The thermal noise W is transformed to a noise vector V where V=Q^{H}W, and the matrix R is an upper triangular matrix. The search process is based on the transposed system model illustrated in Equation 3 and starts from the bottom layer of the transmitted symbol vector X. The modified search tree 200 resulting from the QR-M algorithm is illustrated in FIG. 2.

For each layer 208, 210, 212 in the search tree 200, a number of candidate nodes are preserved and subtracted from the transformed received signal Z when detecting the next layer. In the search tree 200 preserved candidate nodes are indicated by dark colored nodes, such as the dark color used to shade node 202, while light color nodes, such as the light color used to shade node 216, are pruned or removed from the search tree. In a typical implementation of the QR-M algorithm it is often necessary to retain a fairly large number of nodes in each layer in order to preserve near MLD performance. Therefore, because the total number of retained nodes remains relatively large, the total complexity is often still prohibitively high for implementation in many UE designs.

An exemplary embodiment of a detection method as used by a detector according to an embodiment of the present disclosure significantly reduces the complexity of symbol detection through the use of an optimal channel shortening procedure followed by a simplified tree search process. The optimal channel shortening procedure is used to determine an optimal shortened channel matrix H̅ᵣ and corresponding shortened channel correlation matrix Gᵣ based on the mismatched received signal probability density function (PDF) shown in Equation 4:

\tilde{p}_{Y|X}∝exp(2Re{Y^{H}HᵣX}−X^{H}GᵣX). Eq. 4

The transmitted data X and received data Y may be assumed to be jointly Gaussian. Using Eigen value decomposition allows a shortened channel correlation matrix Gᵣ to be decomposed into a unitary matrix U and a diagonal Eigen value matrix Λ^{g} as Gᵣ=UΛ^{g} U^{H}. Λ^{g} is a diagonal Eigenvalue matrix: Λ^{g}=diag(λ₁^{g},λ₂^{g}, . . . λ_{N}^{g}) where λᵢ^{g} are the Eigen values of the shortened channel correlation matrix Gᵣ.

Let the transformed received symbol vector Z=U^{H}X=(z₁,z₂, . . . ,z_{N})^{T} denote the received data after preprocessing with the unitary matrix U, then the probability function of the received data Y can be described as shown in Equation 5:

$$\begin{matrix}{\tilde{p}}_{Y} = {\int }_{X} {\tilde{p}}_{Y \vert X} {p}_{X} dX = \frac{1}{{π}^{N}} {\int }_{X} exp ( 2 Re \{ {Y}^{H} {H}_{r} X \} - {Z}^{H} {Λ}^{g} Z ) exp ( - {Z}^{H} Z ) dZ \\ = \frac{1}{{π}^{N}} {\int }_{X} exp ( 2 Re \{ {Z}^{H} D \} - {Z}^{H} ( {Λ}^{g} + I ) Z ) dZ \\ = \frac{1}{{π}^{N}} {\int }_{X} {Π}_{k = 1}^{N} exp ( 2 Re \{ {z}_{k}^{*} {d}_{k} \} - \vert {z}_{k} {\vert}^{2} ( {λ}_{k}^{g} + 1 ) ) {dz}_{k} \\ = \frac{1}{{π}^{N \text{/} 2}} {Π}_{k = 1}^{N} \frac{1}{( {λ}_{k}^{g} + 1 )} exp ( \frac{\vert {d}_{k} {\vert}^{2}}{{λ}_{k}^{g} + 1} ) ∝ {Π}_{k = 1}^{N} \frac{1}{( {λ}_{k}^{g} + 1 )} exp ( \frac{\vert {d}_{k} {\vert}^{2}}{{λ}_{k}^{g} + 1} )\end{matrix} . \qquad Eq . 5$$

where the vector D=(Y^{H}HᵣU)^{H}=(d₁,d₂, . . . ,d_{N})^{T} is a column vector.

The expected value of the probability with respect to the received signal Y, denoted by E_{Y}, is shown in Equation 6:

$$- {E}_{Y} ( {log}_{2} ( {\tilde{p}}_{Y} ) ) = {\sum }_{k = 1}^{N} ( {log}_{2} ( {λ}_{k}^{g} + 1 ) + \frac{{E}_{Y} ( \vert {d}_{k} {\vert}^{2} )}{{λ}_{k}^{g} + 1} ) . \qquad Eq . 6$$

By defining an upper triangular matrix R as shown in Equation 7:

R=E(DD^{H})=U^{H}Hᵣ^{H}E(YY^{H})HᵣU=U^{H}Hᵣ^{H}(HH^{H}+σ²I)HᵣU, Eq. 7

the expected value E_{Y} can be re-written as shown in Equation 8:

$$- {E}_{Y} ( {log}_{2} ( {\tilde{p}}_{Y} ) ) = {\sum }_{k = 1}^{N} ( {log}_{2} ( {λ}_{k}^{g} + 1 ) + \frac{{R}_{kk}}{{λ}_{k}^{g} + 1} ) . \qquad Eq . 8$$

It can be shown that the expected value relationship illustrated below in Equation 9 holds for the above described system:

E_{X,Y}(log₂(\tilde{p}_{Y|X}))=E_{X,Y}(2Re{Y^{H}HᵣX}−X^{H}GᵣX)=2Re{tr(Hᵣ^{H}H)}−tr(Gᵣ). Eq. 9

The lower bound of the achievable information rate can be found as shown in Equation 10:

$$\tilde{I} = - {E}_{Y} ( {log}_{2} ( {\tilde{p}}_{Y} ) ) + {E}_{X , Y} ( {log}_{2} ( {\tilde{p}}_{Y \vert X} ) ) = {\sum }_{k = 1}^{N} ( {log}_{2} ( {λ}_{k}^{g} + 1 ) + \frac{{R}_{kk}}{{λ}_{k}^{g} + 1} - {λ}_{k}^{g} ) + 2 Re \{ tr ( {H}_{r}^{H} H ) \} \qquad Eq . 10$$

Applying the above definitions leads to the relationship shown in Equation 11:

$$\begin{matrix}{\sum }_{k = 1}^{N} ( \frac{{R}_{kk}}{{λ}_{k}^{g} + 1} ) = tr ( {R ( {Λ}^{g} + I )}^{- 1} ) = tr ( {U}^{H} {H}_{r}^{H} ( {HH}^{H} + {σ}^{2} U ) {H}_{r} {U ( {Λ}^{g} + I )}^{- 1} ) \\ = tr ( {H}_{r}^{H} ( {HH}^{H} + {σ}^{2} I ) {{H}_{r} ( {G}_{r} + I )}^{- 1} )\end{matrix} . \qquad Eq . 11$$

The optimal shortened channel matrix H̅ᵣ can be found by taking the partial derivative of the lower bound of the achievable information rate Ĩ with respect to the Hermitian transpose of the shortened channel matrix Hᵣ^{H}, and setting the result to zero as shown in Equation 12:

$$\begin{matrix}\frac{\partial \tilde{I}}{\partial {H}_{r}^{H}} = \frac{\partial ( tr ( 2 Re \{ {H}_{r}^{H} H \} - {H}_{r}^{H} ( {HH}^{H} + {σ}^{2} I ) {{H}_{r} ( {G}_{r} + I )}^{- 1} ) )}{\partial {H}_{r}^{H}} \\ = {( H - ( {HH}^{H} + {σ}^{2} I ) {{H}_{r} ( {G}_{r} + I )}^{- 1} )}^{H} = 0\end{matrix} \qquad Eq . 12$$

The optimal shortened channel matrix H̅ᵣ can now be obtained as shown in Equation 13:

H̅ᵣ=(HH^{H}+σ²I)⁻¹H(Gᵣ+I). Eq. 13

Putting the optimal shortened channel matrix H̅ᵣ, illustrated in Equation 13, back into the expression for the lower bound of the achievable information rate Ĩ, shown above in Equation 10, yields an expression for the lower bound of the achievable information rate Ĩ as shown in Equation 14:

\tilde{I}=log₂(det(Gᵣ+I))+tr((Gᵣ+I)H^{H}(HH^{H}+σ²I)⁻¹H)−tr(Gᵣ). Eq. 14

Equation 14 can be solved to find the shortened channel correlation matrix Gᵣ by assuming a decomposition of the shortened channel correlation matrix Gᵣ based on a factorization matrix F as shown in Equation 15:

Gᵣ=F^{H}F−I. Eq. 15

where the sum of the shortened channel correlation matrix Gᵣ and the identity matrix I, (Gᵣ+I) is positive definite.

A reduced complexity tree search, referred to herein as an alternative marginalized tree search (AMTS) may be facilitated by using a specially formed factorization matrix F where the factorization matrix F is an N×N upper triangular matrix having the form illustrated in Equation 16 where there are non-zero elements on the main diagonal and in the last column and all other elements are zero:

$${F}_{N \times N} = ( \begin{matrix}{f}_{11} & 0 & ⋯ & ⋯ & 0 & {f}_{1 N} \\ 0 & {f}_{22} & ⋱ & ⋮ & 0 & {f}_{2 N} \\ ⋮ & ⋱ & ⋱ & ⋱ & 0 & ⋮ \\ ⋮ & ⋮ & ⋱ & ⋱ & 0 & ⋮ \\ ⋮ & ⋮ & ⋮ & ⋱ & {f}_{( N - 1 ) ( N - 1 )} & {f}_{( N - 1 ) N} \\ 0 & ⋯ & ⋯ & ⋯ & 0 & {f}_{NN}\end{matrix} ) . \qquad Eq . 16$$

The lower bound of the achievable information rate Ĩ can be re-written based on the factorization matrix F as shown in Equation 17:

$$\begin{matrix}\tilde{I} = {log}_{2} ( det ( {F}^{H} F ) ) + tr ( {F}^{H} {{FH}^{H} ( {HH}^{H} + {σ}^{2} I )}^{- 1} H ) - tr ( {F}^{H} F - I ) \\ = {log}_{2} ( det ( {F}^{H} f ) ) + tr ( F ( {{H}^{H} ( {HH}^{H} + {σ}^{2} I )}^{- 1} H - I ) {F}^{H} ) + tr ( I )\end{matrix} . \qquad Eq . 17$$

A mean square error (MSE) matrix B can be derived from the channel matrix H as shown in Equation 18:

B=I−H^{H}(HH^{H}+σ²I)H. Eq. 18

Because the factorization matrix F is an upper triangular matrix a relationship between the lower bound of the achievable information rate Ĩ and the MSE matrix B can be written as shown in Equation 19:

$$\tilde{I} = {\sum }_{k = 1}^{N} {log}_{2} ( {f}_{kk} , {f}_{kk}^{*} ) - tr ( {FBF}^{H} ) + N . \qquad Eq . 19$$

The k^{th} diagonal element (FBF^{H})ₖ of matrix FBF^{H} can be calculated as shown in Equation 20:

$${( {FBF}^{H} )}_{k} = ( {f}_{kk} {f}_{kN} ) ( \begin{matrix}{b}_{kk} & {b}_{kN} \\ {b}_{kN}^{*} & {b}_{NN}\end{matrix} ) ( \begin{matrix}{f}_{kk}^{*} \\ {f}_{kN}^{*}\end{matrix} ) , \qquad Eq . 20$$

were bₖⱼ represent the k^{th} row and j^{th} column element of the MSE matrix B, and fₖⱼ represents the k^{th} row and j^{th} column element of the factorization matrix F.

Taking the partial derivative of the lower bound of the achievable information rate Ĩ with respect to the complex conjugate of the elements of the last column of factorization matrix f*_{kN} and setting the result equal to zero as shown in Equation 21:

$$\frac{\partial \tilde{I}}{\partial {f}_{kN}^{*}} = - ( {f}_{kk} {b}_{kN} + {f}_{kN} {b}_{NN} ) = 0. \qquad Eq . 21$$

yields a relationship between the elements of the factorization matrix F and the elements of the MSE matrix B as shown in Equation 22:

$${f}_{kN} = - \frac{{f}_{kk} {b}_{kN}}{{b}_{NN}} . \qquad Eq . 22$$

Using the result found in Equation 22 in the lower bound of the achievable information rate Ĩ, i.e. putting f_{kN} from Equation 22 into Equation 19, and taking the partial derivative of the lower bound of the achievable information rate Ĩ with respect to the complex conjugate of the elements of the last column of the factorization matrix f*_{kN} and setting the result equal to zero as shown in Equation 23:

$$\frac{\partial \tilde{I}}{\partial {f}_{kN}^{*}} = - ( {f}_{kk} {b}_{kN} + {f}_{kN} {b}_{NN} ) = 0 , \qquad Eq . 23$$

provides a relationship between the elements of the factorization matrix fₖⱼ and the elements of the MSE matrix bₖⱼ shown in Equation 24:

$${f}_{kk} = \frac{1}{\sqrt{{b}_{kk} - \vert {b}_{kN} {\vert}^{2} \text{/} {b}_{NN}}} . \qquad Eq . 24$$

The factorization matrix F may be uniquely obtained from the MSE matrix B according to Equation 24. The shortened channel correlation matrix Gᵣ may then be obtained using Equation 15, and the optimal shortened channel matrix H̅ᵣ may be obtained using Equation 13. Thus once the special form of the factorization matrix F has been specified as illustrated in Equation 16, the shortened channel correlation matrix Gᵣ can be derived from the MSE matrix B where the elements of the shortened channel correlation matrix Gᵣ are calculated according to Equation 25:

$${g}_{kl} = \{ \begin{matrix}\frac{{b}_{NN}}{{b}_{kk} {b}_{NN} - {b}_{kN} {\vert}^{2}} - 1 & i = k \neq N \\ \frac{1}{{b}_{NN}} - 1 & i = k = N \\ \frac{- {b}_{kL}}{{b}_{kk} {b}_{NN} - \vert {b}_{kN} {\vert}^{2}} & i = N , k \neq N \\ {g}_{ik}^{*} & i \neq N , k = N \\ 0 & else\end{matrix} , \qquad Eq . 25$$

where bᵢⱼ is the element of the MSE matrix B at the i^{th} row and j^{th} column and as before N is the number of transmitted layers.

Using the shortened channel correlation matrix Gᵣ obtained from Equation 25, the a priori probability can be rewritten as shown in Equation 26:

$$In ( {\tilde{p}}_{Y \vert X} ) ∝ 2 Re \{ {{Y}^{H} ( {HH}^{H} + {σ}^{2} I )}^{- 1} H ( {G}_{r} + I ) X \} - {X}^{H} {G}_{r} X = 2 Re \{ {[ {{H}^{H} ( {HH}^{H} + {σ}^{2} I )}^{- 1} Y ]}^{H} ( {G}_{r} + I ) X \} - {X}^{H} {G}_{r} X = 2 Re \{ {Z}^{H} ( {G}_{r} + I ) X \} - {X}^{H} {G}_{r} X \qquad Eq . 26$$

The pre-processed symbol vector Z^{H}=(z(1),z(2), . . . z(N)) is equal to the LMMSE estimation of the transformed received symbol vector Z and may be defined as shown in Equation 27:

Z=H^{H}(HH^{H}+σ²I)⁻¹Y. Eq. 27

Once the optimal shortened channel matrix H̅ᵣ and corresponding shortened channel correlation matrix Gᵣ have been obtained, a low complexity AMTS may be used to find the transmitted symbols. Based on the a priori probability shown in Equation 26 a path metric for each candidate path X=(x(1),x(2), . . . x(N)) may be defined as shown in Equation 28:

$$γ ( x ( 1 ) , x ( 2 ) , … x ( N ) ) = 2 Re \{ {Z}^{H} ( {G}_{r} + I ) X \} - {X}^{H} {G}_{r} X = {\sum }_{k = N}^{1} {γ}_{k} ( z ( k ) , x ( k ) , x ( N ) ) . \qquad Eq . 28$$

A path metric for the kth layer can be defined as in Equation 29:

$${γ}_{k} ( z ( k ) , x ( k ) , x ( N ) ) = \{ \begin{matrix}Re \{ ( 2 ( z ( k ) - {g}_{Nk} {x ( N )}^{*} ) - {g}_{kk} {x ( k )}^{*} ) x ( k ) \} & k \neq N \\ Re \{ ( 2 z ( N ) - {g}_{NN} {x ( N )}^{*} ) x ( N ) \} & k = N\end{matrix} . \qquad Eq . 29$$

From the a priori probability shown in Equation 26 it can be seen that the best path is the one that maximizes the accumulated path metric γ. However, because of the special form of the shortened channel correlation matrix Gᵣ, maximizing the accumulated path metric γ is equivalent to maximizing each path metric γₖ at the k^{th} layer separately as illustrated in Equation 30:

$$arg max \{ γ ( x ( 1 ) , x ( 2 ) , … x ( M ) ) \} = arg max \{ {\sum }_{k = N}^{1} {γ}_{k} ( z ( k ) , x ( k ) , x ( N ) ) \} = {\sum }_{k = N}^{1} arg max \{ {γ}_{k} ( z ( k ) , x ( k ) , x ( N ) ) \} . \qquad Eq . 30$$

The relationship illustrated in Equation 30 shows that the search of the optimal candidate x(k) for each layer may be done by independently maximizing an individual layer branch metric γₖ for each layer. This allows the selection of each candidate to be handled in parallel. The parallel structure of the AMTS is illustrated by the search tree 300 shown in FIG. 3. The search tree 300 includes a root node 302 corresponding to layer being searched. Below the root node 302 is the parent layer 304 which includes one parent node, such as node 306, for each symbol x(N) in the coding scheme used to transmit the parent layer 304.

For example when the parent layer 304 is transmitted using 256QAM there will be 256 parent nodes in the parent layer 304. For clarity, some of the parent nodes and their associated child nodes have been omitted from the tree diagram 300 and replaced with dashed lines 310 indicating where tree branches have been omitted. As used herein, the term “branch” or “tree branch” refers to a node and its associated child nodes. For example the AMTS search tree 300 includes a plurality of parallel branches such as the branch made up of nodes 306, 312, 314, 318. In accordance with certain embodiments of the AMTS method described above, each parent node, such as parent node 306, in the parent layer 304 has a single child node, such as child node 312 and each child node, such as child nodes 312, 314, also has a single child node. As the search progresses a child node 312 is selected for the parent node 306. This child node 312 then becomes the parent node for selection of the child node in the next lower level. This process continues until a node has been selected for all layers in the tree search. Including only a single child node in each child layer significantly reduces the overall complexity of the AMTS as compared to MLD or the QR-M algorithm. While only three child layers 308 are illustrated in the search tree 300 it is understood that when the transmitted signal has more than four layers the search tree 300 will include additional child layers where each child layer 308 corresponds to a layer in the transmitted signal.

In alternate embodiments several candidate nodes may be selected at each child layer by selecting candidate nodes having the highest values of the individual branch metric γₖ. However, in embodiments designed to have the lowest possible complexity, a single best node is chosen under each parent node as illustrated in FIG. 3.

To find the best candidate node in each child layer 308 the maximum value of the individual layer branch metric γₖ needs to be found. The maximum value can be found by taking the partial derivative of the individual branch metric γₖ with respect to each candidate and setting the result equal to zero as shown in Equation 31:

$$\frac{\partial {γ}_{k} ( z ( k ) , x ( k ) , x ( N ) )}{\partial {x ( k )}^{*}} = ( {z}^{*} ( k ) - {g}_{kN} ( N ) ) - {g}_{kk} x ( k ) = 0. \qquad Eq . 31$$

The maximum value can then be found as shown in Equation 32:

$$\hat{x} ( k ) = \frac{{z}^{*} ( k ) - {g}_{kN} x ( N )}{{g}_{kk}} . \qquad Eq . 32$$

When the diagonal value of the shortened channel correlation metric gₖₖ is positive, the individual branch metric γₖ describes a concave surface for the candidate symbol x(k), and the peak value \hat{x}(k) is the maximum point on the surface. In the case of a concave surface the best estimation is provided by Equation 32 and quantizing the peak value \hat{x}(k) to the nearest constellation point in a QAM alphabet provides the best estimate of the candidate symbol x(k).

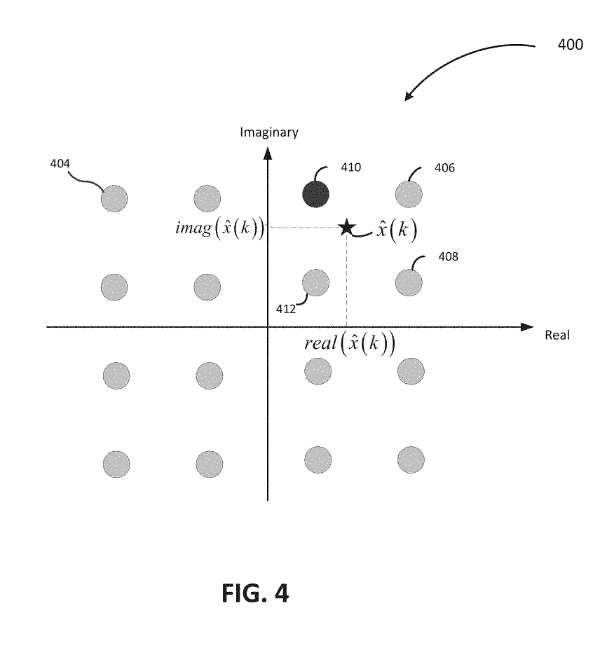

For example, FIG. 4 illustrates an embodiment showing the above described mapping when the modulation scheme is 16QAM. Graph 400 illustrates a real versus imaginary plot of the 16 constellation points of a 16QAM encoding scheme. In the graph 400 real values are represented along the horizontal axis, imaginary values are represented along the vertical axis, and the constellation points are represented by shaded circles, for example shaded circle 404. In the illustrated graph 400 the peak value \hat{x}(k) falls between four constellation points 406, 408, 410, 412. The closest constellation point 410 is then selected as the best candidate symbol x(k).

When the diagonal value of the shortened channel correlation matrix g is non-positive, the individual branch metric γₖ is a convex function and the maximal value is located along the boundaries so the corners of the constellation map need to be considered. Further when the modulus correspond to Equation 33:

$${γ}_{k} ( z ( k ) , x ( k ) , x ( N ) ) = Re \{ ( 2 ( z ( k ) - {g}_{Nk} {x ( N )}^{*} ) - {g}_{kk} {x ( k )}^{*} ) x ( k ) \} ; ∝ Re \{ ( z ( k ) - {g}_{Nk} {x ( N )}^{*} ) x ( k ) \} \qquad Eq . 33$$

the best candidate depends on the quadrant in which the residual signal z*(k)−g_{kN}×(N) is located.

As described above, a single best candidate is selected under each parent node for each layer resulting in significantly lower complexity than MLD. However, preserving only a single candidate node at each layer is essentially sub-optimal. To compensate for this, each layer, or at least portions of the weaker layers are switched to be the parent node and the AMTS process is repeated with each layer as the parent layer. The results of each AMTS leg are then combined to obtain a more reliable result.

Switching of a layer to become the parent layer may be accomplished using a permutation matrix. In an exemplary embodiment, to switch a layer, designated as the j^{th} layer in the following equation, to be the parent layer, a permutation matrix Pⱼ is defined as shown in Equation 34:

$${P}_{j} = ( \begin{matrix}1 & & & & & & \\ 0 & ⋱ & & & & & \\ & ⋱ & 1 & & & & \\ & & 0 & 0 & & & 1 \\ & & & 1 & ⋱ & & \\ & & & & ⋱ & ⋱ & \\ & & & & & 1 & 0\end{matrix} ) \to j \text{-} th row , \qquad Eq . 34$$

where the 1 in the last column to the right corresponds to the j^{th} element and the remaining elements in the last column are zero. The permutation matrix Pⱼ may be used to permute the j^{th} column of a matrix to the last column while keeping the rest of the columns in the same order.

The permutation matrix Pⱼ also has a useful property where pre or post multiplying by its transpose yields the identity matrix: Pⱼ^{T}Pⱼ=PⱼPⱼ^{T}=1. The permutation matrix Pⱼ can be used to switch the j^{th} layer of the received signal model by rewriting Equation 1 as shown in Equation 35:

Y=HPⱼPⱼ^{T}X+N=HⱼXⱼ+N, Eq. 35

Where Hⱼ is a permuted channel matrix and Xⱼ is the permuted transmitted symbol vector permuted according to the permutation matrix Pⱼ.

After post-multiplying with the permutation matrix Pⱼ the column vectors of the permuted channel matrix Hⱼ are re-ordered as shown in Equation 36:

Hⱼ=HPⱼ=(h₁,h₂, . . . hⱼ₋₁,hⱼ₊₁, . . . h_{N},hⱼ), Eq. 36

and after pre-multiplying the elements of the transmitted symbol vector X, with the transpose of the permutation matrix Pⱼ^{T} the elements are re-ordered as shown in Equation 37:

Xⱼ=Pⱼ^{T}X=(x(1),x(2), . . . ,x(j−1),x(j+1), . . . ,x(N−1),x(j))^{T}. Eq. 37

An embodiment of the AMTS process can then be implemented for the j^{th} layer based on the permuted channel matrix Hⱼ and the permuted symbol vector Xⱼ.

Much of the complexity of the channel shortening process can be shared by all the parallel searches of the AMTS. Sharing of portions of the channel shortening process reduces the overall complexity and provides significant complexity savings. With the permuted received signal model described above in equation Eq. 35, the permuted MSE matrix Bⱼ is updated as shown in Equation 38:

Bⱼ=I−Hⱼ^{H}(HⱼHⱼ^{H}+σ²I)⁻¹Hⱼ=I−Pⱼ^{T}H^{H}(HPⱼPⱼ^{T}H^{H}+σ²I)⁻¹HPⱼ=Pⱼ^{T}(I−H^{H}(HH^{H}+σ²I)⁻¹H)Pⱼ=Pⱼ^{T}BPⱼ Eq. 38

The MSE matrix is the original non-permuted MSE matrix defined above. Thus, since P is a permutation matrix, the permuted MSE matrix Bⱼ may be obtained from the MSE matrix B with a negligible increase in complexity.

Similarly the transformed received symbol vector shown in Equation 27 may be permuted to obtain a permuted transformed received symbol vector Zⱼ as shown in Equation 39:

Zⱼ=Pⱼ^{T}H^{H}(HH^{H}+σ²I)⁻¹Y=Pⱼ^{T}Z. Eq. 39

The transformed received symbol vector Z and the corresponding MSE matrix B may be obtained from the initial LMMSE step. Therefore only the shortened channel correlation matrix Gᵣ^{j} needs to be re-calculated based on the permuted MSE matrix Bⱼ after the j^{th} layer is switched to be the parent node.

After application of the permutation, the updated branch metric may be defined as shown in Equation 40:

γ(Xⱼ)=2Re{Zⱼ^{H}(Gᵣ^{j}+I)Xⱼ}−Xⱼ^{H}Gᵣ^{j}Xⱼ. Eq. 40

The remainder of the AMTS process described above remains unchanged for the permuted layer.

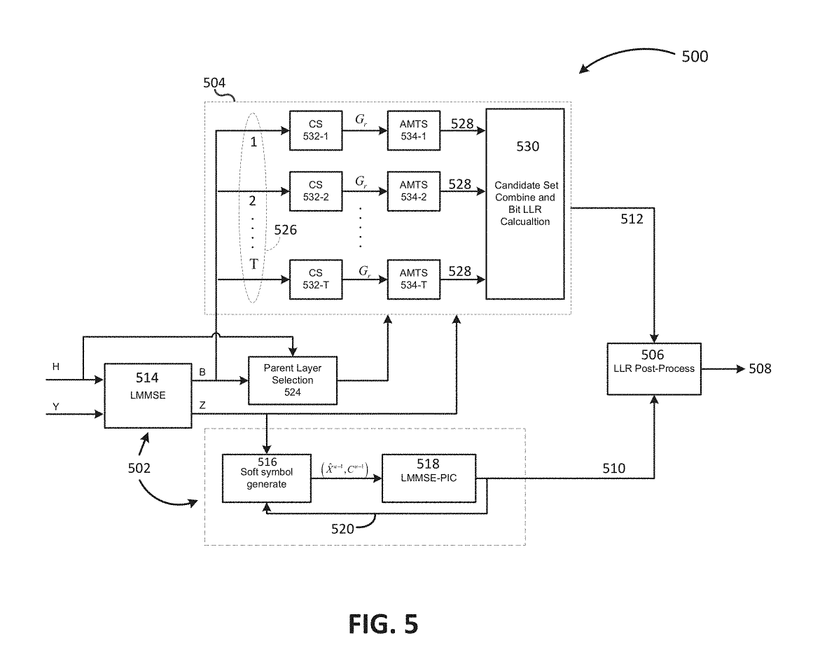

FIG. 5 illustrates a block diagram of an embodiment of an AMTS detector generally indicated by numeral 500. The illustrated embodiment shown in FIG. 5 can be understood by viewing it as implementing a two-step process: a LMMSE based detector step 502 and a parallel marginalized tree search (MTS) process 504. The output from the two steps is combined with an LLR post process 506 to obtain a final set of bit LLR values 508. The illustrated embodiment adopts a linear detector step 502 based on LMMSE with successive and parallel interference cancellation (LMMSE-SPIC). Alternatively the linear detector step 502 may be based on any type of LMMSE detector and may include successive interference cancellation (SIC) and or parallel interference cancellation (PIC).

The illustrated embodiment of the AMTS detector 500 begins by inputting the estimated channel matrix H and received signal Y to an initial LMMSE based step 514 which assumes the noise component to be white. The LMMSE step 514 produces a MSE matrix B and an estimated transformed received symbol vector Z. When PIC is included in the LMMSE step 514 the symbol estimation is input to a soft symbol regeneration module 516 that produces a soft symbol estimation \hat{X}^{u-1} and a corresponding covariance matrix C^{u-1}. Since the estimation process is iterative the superscript u is used to indicate the current iteration number and the superscript u−1 is used to indicate that these estimations are for the u minus 1 or previous iteration. The soft symbol estimation \hat{X}^{u-1} and a corresponding covariance matrix C^{u-1} are input to a LMMSE-PIC process 518 to produce a first set of bit-LLR 510 which is fed back 520 to the soft symbol regeneration module 516. Once a desired number of iterations has been completed the final first set of bit-LLR 510 is provided to the LLR post process 506. The self-iterative LMMSE-PIC detector 518 may be summarized as shown in Equation 41:

$${\hat{X}}^{u} = {\hat{X}}^{u - 1} + \frac{{{H}^{H} ( {HC}^{u - 1} {H}^{H} + {σ}^{2} I )}^{- 1}}{diag ( {{H}^{H} ( {HC}^{u - 1} {H}^{H} + {σ}^{2} I )}^{- 1} H )} ( Y - H {\hat{x}}^{u - 1} ) . \qquad Eq . 41$$

The bit-LLR can be calculated based on the symbol estimation \hat{X}^{u} for a specific modulation type. The bit-LLR can then be used by the soft symbol regeneration process to create a soft symbol estimation \hat{X} and covariance matrix C for the next iteration.

The parallel marginalized tree search (MTS) process 504 has a number of parallel legs 526 where each leg (wherein each leg can be processed in parallel by the detector 500), labeled as leg 1 through T, includes a channel shortening process 532 and an AMTS process 534. The channel shortening process 532 and AMTS process 534 for each parallel leg 526 share the same processes with a different transmitted layer switched to be the parent layer. Selection of the parent layers is described in more detail below. The outputs 528 from each parallel MTS leg 526 are combined in a candidate set combination and bit LLR calculation process 530 to produce a single output 512.

The estimated channel matrix H and MSE matrix B of FIG. 5 are provided to a parent layer selection module 524 to select which layers will be used as parent layers in the parallel MTS process 504. In certain embodiments it is desirable to reduce the complexity of the MTS process by having fewer parallel searches or legs than there are layers in the received signal. This can be expressed as: T<=N, where N is the number of layers in the received signal and T is the number of parent layers selected or the number of parallel legs in the search process 504. When T is less than N the layers to be used as parent layers need to be selected from the full set of transmitted layers. In certain embodiments selection of the parent layers 524 may be based on energy or mean square error. Let the channel matrix be represented as shown in Equation 42:

H=(h₁,h₂, . . . ,hⱼ₋₁,hⱼ,hⱼ₊₁, . . . h_{N}), Eq. 42

where hᵢ(1≦i≦N) represents the i^{th} column vector.

For energy based parent layer selection the layers chosen to be the parent layers of each parallel leg correspond to the channel vectors h_{K}_{ᵢ} (1≦i≦T) that satisfy the condition shown in Equation 43:

∥h_{K}_{ᵢ}∥≦∥hⱼ∥, where 1≦i≦T, and 1≦j≠Kᵢ≦N. Eq. 43

Alternatively, parent layer selection 524 may be based on the MSE matrix B obtained from the first LMMSE module 514. This approach is equivalent to basing selection on channel capacity. With channel capacity selection, the layers chosen to be parent layers correspond to the maximal diagonal elements of the MSE matrix B. Since the MSE matrix B is a square N by N matrix let its elements be represented by a lower case b as B=(bᵢⱼ)_{N×N} where the subscripts i and j represent the row and column position of the element b respectively.

The layers chosen to be the parent layers correspond to the elements from the main diagonal of the MSE matrix B, b_{K}_{ᵢ}_{K}_{ᵢ}(1≦i≦T), that satisfy the condition shown in Equation 44:

b_{K}_{ᵢ}_{K}_{ᵢ}≧bⱼⱼ, where 1≦i≦T, and 1≦j≠Kᵢ≦N. Eq. 44

Once the parent layers have been selected 524 a permutation matrix Pⱼ is used as described above to switch each selected layer to be the parent layer of one parallel leg 526. A channel shortening process 532 creates a shortened channel correlation matrix Gᵣ corresponding to the parent layer selected for each parallel leg 526. As described above the channel shortening processes 532 all use the same process for creating the shortened channel correlation matrix Gᵣ which allows a large portion of the computational complexity to be shared. The shortened channel correlation matrix Gᵣ is then used in an AMTS 534 to obtain a candidate set of bit-LLR 528. The candidate sets of bit-LLR 528 are then combined 530 and a final set of bit-LLR 512 is calculated.

In certain embodiments the number of parallel legs is less than the total number of layers that need to be detected. In these embodiments, since not all layers have a chance to be a parent node, no bit combination assumptions will occur in as candidate paths in one of the parallel legs 526 and not all bit-LLR values will be calculated by the AMTS 528. This may be referred to as the missing bit problem.

For the layers that have been chosen to be a parent node of one of the parallel AMTS legs 526, the bit-LLR calculation is simply based on the corresponding AMTS leg and since all assumptions for the parent node have been preserved there is no missing bit problem. For example, assume the layer chosen to be the parent node is modulated with 64QAM, the bit-LLR calculation will be calculated among the final 64 surviving paths as illustrated in the tree diagram of FIG. 3. Each bit will have 32 surviving paths corresponding to a bit hypothesis of 0 and 32 surviving paths corresponding to a bit hypothesis of 1 as illustrated by Equation 45:

$$LLR ( {b}_{i} ) = {arg max}_{{b}_{i} = 1 , {b}_{i} ∈ x ( N )} \{ γ ( x ( 1 ) , x ( 2 ) , … x ( N ) ) \} - {arg max}_{{b}_{i} = 0 , {b}_{i} ∈ x ( N )} \{ γ ( x ( 1 ) , x ( 2 ) , … x ( N ) ) \} , \qquad Eq . 45$$

where bᵢ is the i-th bit of the parent node x(N).

It is often the case that an embodiment will use a number of parallel AMTS legs T that is less than the number of layers, N, in the transmitted signal, i.e the number of AMTS legs T is less than the number of layers N that needs to be detected. In embodiments where the number of parallel legs T is less than the number of received layers N not all the possible bit combinations are to be included in the search process and the missing bit problem needs to be solved. There are a number of alternatives for solving the missing bit problem which will be presented in the following.

For example, in certain embodiments the sign of the bit-LLR output from the AMTS 534 may be used. Although the bit-LLR for the missing bit combinations cannot be calculated, the sign of the bit-LLR is known. Thus the sign of the bit-LLR may be used to reconstruct the missing bit-LLR values as follows, when the sign of the bit-LLR output from the AMTS 534 is the same as the sign of the bit-LLR 510 output from the SPIC module, the bit-LLR 510 output from the SPIC module is used as the final output; and when the sign of the bit-LLR 510 output from the AMTS 534 is different than the sign of the bit-LLR 510 output from the SPIC module, the negative of the bit-LLR 510 output from the SPIC module is used as the final output.

Finally the bit-LLR 512 of bits that do not have the “missing bit” issue from AMTS detection module 504 are combined with the bit-LLR 510 from the LMMSE or LMMSE-SPIC detector 502 in an LLR post process 506. In certain embodiments the LLR post process 506 combines the bit-LLR 510 from the linear detector 502 with the bit LLR outputs 512 from the AMTS detector 504 based on a simple linear averaging. Alternatively, embodiments of the LLR post process 506 can use adaptive averaging where the averaging factor can be based on the measured signal to noise ratio (SNR).

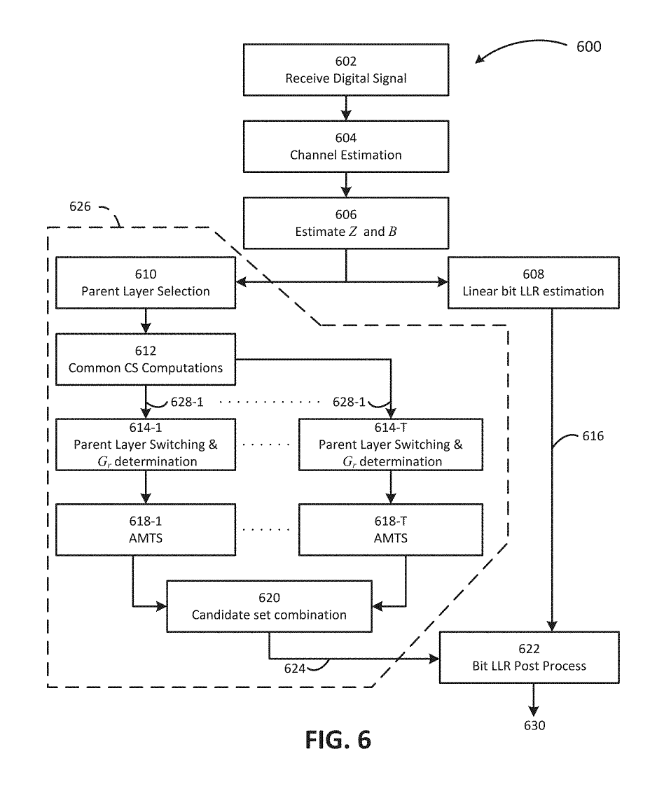

FIG. 6 illustrates a flow chart of a method 600 according to an embodiment for detecting data in a MIMO communication signal. The communication signal is a MIMO type communication signal as is received at a UE where the communication signal may be down converted and appropriately conditioned before being sampled to create a digital data signal. The exemplary embodiment of a method 600 for detecting data begins with step 602 where a digital communication signal is received. Portions of the received digital signal are then used in a channel estimation step 604 to determine an estimated channel matrix H. The estimated channel matrix H and the received digital signal Y are passed through a linear equalizer step 606, for example an LMMSE type equalizer, to determine an estimated transformed received symbol vector Z and a MSE matrix B. The estimated transformed received symbol vector Z and the MSE matrix B are then used in a pair of detection steps 608, 626 to produce a first 616 and second 624 set of bit LLR estimates. As indicated in the exemplary method 600 the two detection steps, 608 and 626, may be performed in parallel or when desired they may be performed serially in either order. One of the detection steps 608 uses linear techniques to estimate the first set of bit LLR 616. The linear detection step 608 may use any appropriate linear estimation technique such as for example a LMMSE detector, LMMSE-SIC, LMMSE-PIC, or a combination of LMMSE with both PIC and SIC as discussed above and with reference to FIG. 5.

The detection step 626 is based on a novel simplified tree search process described above. This novel simplified tree search process used in the detector step 626 begins with a parent layer selection process 610 where the layers in the received digital signal that are to be used as parent layers in the parallel legs, depicted as parallel legs 628-1 through 628-T in FIG. 6, of a novel simplified MTS referred to herein as AMTS are selected. As described above, the sub-optimal nature of the AMTS is mitigated by performing multiple AMTS searches in parallel 628-1 through 628-T, where T represents the number layers selected to be parent layers, which is also the number of legs or AMTS searches being performed in parallel. The number of parallel legs T selected may be less than or equal to the number of layers N in the received digital signal. A special channel shortening process is used to obtain a shortened channel correlation matrix Gᵣ for each leg 628-1 to 628-T. A significant portion of the processing necessary to obtain the shortened channel correlation matrices is common to all the legs 628-1 through 628-T and therefore may be performed only once in a common computation step 610 and shared among all the AMTS legs 628-1 through 628-T. Each leg 628-1 through 628-T then switches a layer to be the parent layer for that leg in a parent layer switching step 614-1 to 614-T and completes generation of the corresponding shortened channel correlation matrix Gᵣ. Switching of the parent layer performed in step 614 is done using a permutation matrix Pⱼ as described above thereby preventing switching of the parent layers from adversely impacting the computational complexity. Once the special form of the shortened channel correlation matrix Gᵣ has been obtained, a set of AMTS steps 618-1 to 618-T may be performed in parallel using a branch metric based on the shortened channel correlation matrix Gᵣ as described above. The AMTS steps 618-1 to 618-T may be configured to select one or more child nodes below each node in the parent layer, however the minimal complexity case will select only a single node below each parent node and each child node will itself have only a single child node selected. Selection of the child nodes, as described above is based on the branch metric for each parallel leg 628-1 through 628-T. The property of the legs 628-1 through 628-T to be processed in parallel provides the advantage of using multiple processors or processing cores to reduce the amount of time required to determine the second 624 set of bit log likelihood estimates. A bit LLR post processing step 622 then uses the two sets of bit LLR estimates 616 and 624 to produce a refined set of bit LLR values 630 to be used for detecting the data. The LLR post processing step 622 may combine the first 616 and second 624 sets of bit LLR values based on a simple linear averaging or alternatively it may use adaptive averaging where the averaging factor can be based on measured SNR values.

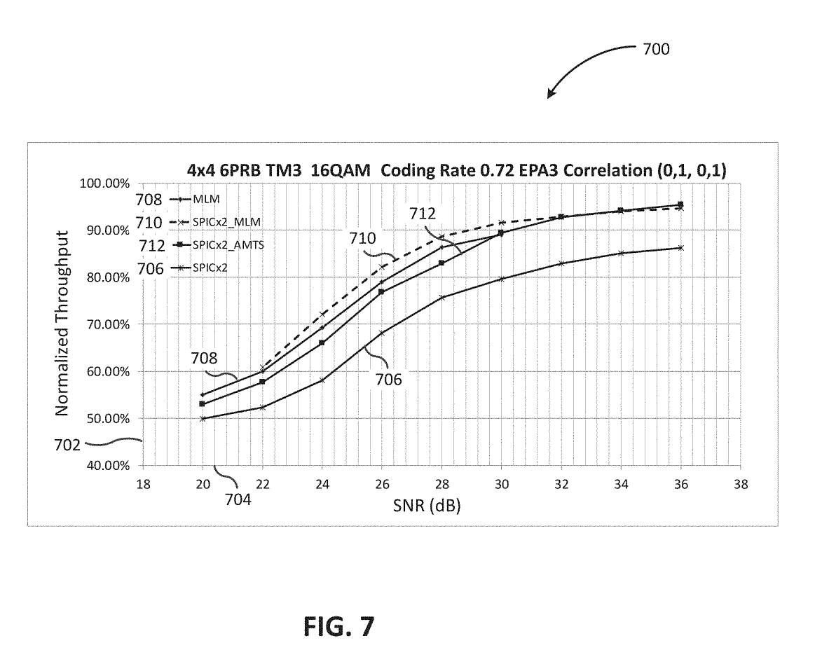

Improved throughput obtained with the above described embodiments can be seen through simulations based on industry standard transmission modes, such as transmission mode 3 (TM3) of a LTE system as defined by the 3GPP. FIG. 7 illustrates a graph 700 of normalized throughput, represented as a percentage plotted along the vertical axis 702, versus SNR represented in decibels (dB) plotted along the horizontal axis 704. The graph 700 illustrates throughput 702 for a 4×4 MIMO system where all layers use 64QAM modulation with a coding rate of 0.72. The simulations are for an Extended Pedestrian-A channel with a UE speed of 3 Km/h (EPA3). The correlation is use-defined with alpha=beta=0.1 and the bandwidth is set to 1.4 megahertz (MHz). A lower bound for the throughput 706 is obtained with a simple linear detector designated SPIC×2 in FIG. 7. SPIC×2 represents a LMMSE-SPIC detector with two iterations including an LMMSE step followed by a single SPIC iteration. A second simulation result shows the throughput 708 obtained using an optimal mixed logical dynamic (MLD) model, designated as MLM, and an upper bound for throughput 710, designated SPIC×2_MLM, is obtained by averaging the output from a pair of detectors, a MLD and a SPIC×2 detector. The throughput obtained with an embodiment of the above described dual detector 712 is labeled as “SPIC×2_AMTS”. The throughput 712 is based on a dual AMTS and linear detector as illustrated in FIG. 5. The simulation results in graph 700 show that the newly disclosed dual detector SPIC×2_AMTS 712 provides throughput performance nearly as good as the optimal MLD based approaches with much lower complexity.

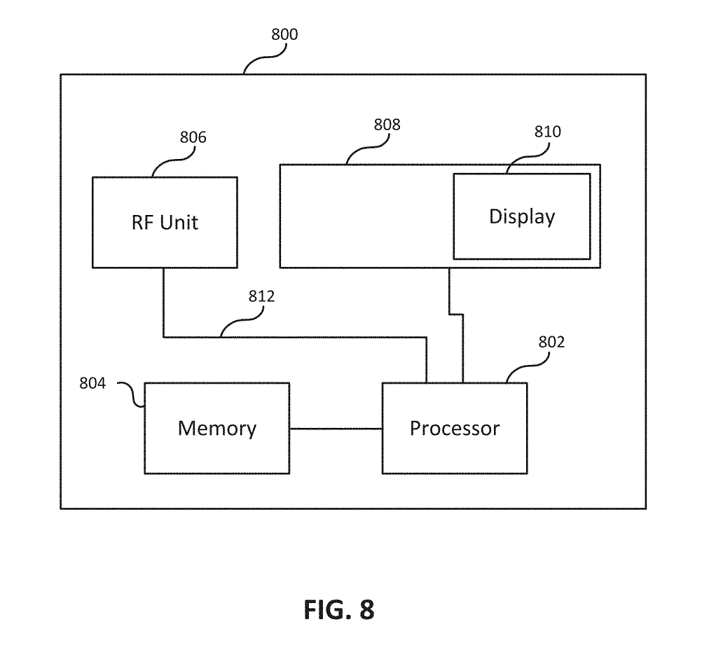

FIG. 8 illustrates a block diagram of an apparatus or mobile device 800 incorporating aspects of the disclosed embodiments. The mobile device 800 is appropriate for implementing the detection techniques described above. The illustrated mobile device 800 includes a processor 802 (e.g. implementing the detector 500) coupled to a memory 804, a radio frequency (RF) unit 806, a user interface (UI) 808, and a display 810. The apparatus 800 is appropriate for use as a mobile device which may be any of various types of wireless communications user equipment such as cell phones, smart phones, or tablet devices.

The processor 802 may be a single processing device or may comprise a plurality of processing devices including special purpose devices such as for example it may include digital signal processing (DSP) devices, microprocessors, or other specialized processing devices as well as one or more general purpose computer processors. The processor 802 is configured to perform the before mentioned processes. The processor 802 is coupled to a memory 804 which may be a combination of various types of volatile and/or non-volatile computer memory such as for example read only memory (ROM), random access memory (RAM), magnetic or optical disk, or other types of computer memory. The memory 804 stores computer program instructions that may be accessed and executed by the processor 802 to cause the processor 802 to perform a variety of desirable computer implemented processes or methods such as the detection methods described above. The program instructions stored in memory 804 may be organized as groups or sets of program instructions referred to by those skilled in the art with various terms such as programs, software components, software modules, units, etc., where each software component may be of a recognized type such as an operating system, an application, a device driver, or other conventionally recognized type of software component. Also included in the memory 804 are program data and data files which are stored and processed by the computer program instructions.

The RF Unit 806 is coupled to the processor 802 and configured to transmit and receive RF signals based on digital data 812 exchanged with the processor 802. The RF Unit 806 is configured to transmit and receive radio signals that may conform to one or more of the wireless communication standards in use today, such as for example LTE, LTE-A, Wi-fi, as well as many others. The RF Unit 806 may receive radio signals from one or more antennas, down-convert the received RF signal, perform appropriate filtering and other signal conditioning operations, then convert the resulting baseband signal to a digital signal by sampling with an analog to digital converter. The digitized baseband signal also referred to herein as a digital communication signal is then sent 812 to the processor 802.

The UI 808 may include one or more user interface elements such as a touch screen, keypad, buttons, voice command processor, as well as other elements adapted for exchanging information with a user. The UI 808 may also include a display unit 810 configured to display a variety of information appropriate for a mobile device or apparatus 800 and may be implemented using any appropriate display type such as for example organic light emitting diodes (OLED), liquid crystal display (LCD), as well as less complex elements such as LEDs or indicator lamps, etc. In certain embodiments the display unit 810 incorporates a touch screen for receiving information from the user of the mobile device 800. In certain embodiments the UI 808 may be omitted. The mobile device 800 is appropriate for implementing embodiments of the apparatus and methods disclosed herein.

Thus, while there have been shown, described and pointed out, fundamental novel features of the disclosure as applied to the exemplary embodiments thereof, it will be understood that various omissions, substitutions and changes in the form and details of devices and methods illustrated, and in their operation, may be made by those skilled in the art without departing from the spirit and scope of the disclosure. Further, it is expressly intended that all combinations of those elements, which perform substantially the same function in substantially the same way to achieve the same results, are within the scope of the disclosure. Moreover, it should be recognized that structures and/or elements shown and/or described in connection with any disclosed form or embodiment of the disclosure may be incorporated in any other disclosed or described or suggested form or embodiment as a general matter of design choice. It is the intention, therefore, to be limited only as indicated by the scope of the claims appended hereto.

What is claimed is:

1. An apparatus comprising:
a memory comprising computer program instructions; and
a processor configured to execute the computer program instructions to cause the apparatus to:
receive a digital communication signal, the digital communication signal comprising a plurality of transmitted layers;
determine an estimated channel matrix based on the digital communication signal;
determine a first estimated transmitted symbol vector and a mean square error matrix based on a linear analysis of the received digital communication signal;
determine a first set of bit log likelihood ratios by performing linear minimum mean square error detection based on the first estimated transmitted symbol vector;
determine a second set of bit log likelihood ratios by performing a tree search for one or more layers in the plurality of transmitted layers in the digital communication signal based on the first estimated transmitted symbol vector and the mean square error matrix;
determine a refined set of bit log likelihood ratios based on the first set of bit log likelihood ratios and the second set of bit log likelihood ratios; and
determine a second estimated transmitted symbol vector based on the refined set of bit log likelihood ratios, wherein the tree search comprises:
select a set of parent layers from the plurality of transmitted layers, wherein a number of layers in the set of parent layers is less than or equal to a number of layers in the plurality of transmitted layers;
determine a shortened channel correlation matrix for each layer in the set of parent layers based on the mean square error matrix;
determine an optimal shortened channel matrix based on each determined shortened channel correlation matrix and the estimated channel matrix; and
select a single child node for each parent node in the tree search based on evaluation of a branch metric.

2. The apparatus of claim 1, wherein the processor being configured to execute computer program instructions to cause the apparatus to determine the first set of bit log likelihood ratios is based on an output of a detector comprising one or more of: a linear minimum mean square error detector, successive interference cancellation, and parallel interference cancellation.

3. The apparatus of claim 1, wherein the processor is further configured to execute the computer program instructions to cause the apparatus to evaluate the branch metric based on the shortened channel correlation matrix and a single parent node.

4. The apparatus of claim 1, wherein the processor is further configured to execute the computer program instructions to cause the apparatus to select the single child node as the node having a maximum value of the branch metric.

5. The apparatus of claim 1, wherein the processor is further configured to execute the computer program instructions to cause the apparatus to perform the tree search for each parent layer in the set of parent layers in parallel.

6. The apparatus of claim 1, wherein the processor is further configured to execute the computer program instructions to cause the apparatus to:
select the child node having a peak value of the branch metric when the corresponding element of the shortened channel correlation matrix is positive; and
select the child node based on a quadrant of a residual value when the corresponding element of the shortened channel correlation matrix is negative.

7. The apparatus of claim 1, wherein the number of parent layers is smaller than the number of transmitted layers, and wherein the processor is further configured to execute the computer program instructions to cause the apparatus to select the parent layers in the set of parent layers based on an amount of energy or a channel capacity of the plurality of transmitted layers.

8. The apparatus of claim 1, wherein the processor being configured to determine the refined set of the bit log likelihood ratios comprises the processor further configured to execute computer program instructions to further cause the apparatus to:
determine a sign of the bit log likelihood ratio corresponding to a missing bit hypothesis when the second set of bit log likelihood ratios is missing a bit hypothesis; and
determine the refined set of bit log likelihood ratios based on the sign and the first set of log likelihood ratios.

9. The apparatus of claim 1, wherein the processor is further configured to execute the computer program instructions to cause the apparatus to determine the shortened channel correlation matrix based on a mismatched received signal probability density function.

10. The apparatus of claim 1, wherein the processor is further configured to execute the computer program instructions to cause the apparatus to determine the shortened channel correlation matrix based on a factorization matrix, wherein the factorization matrix comprises non-zero elements on a main diagonal of the factorization matrix, non-zero elements in a last column of the factorization matrix, and the remaining elements of the factorization matrix have a zero value.

11. The apparatus of claim 1, wherein the processor is further configured to execute the computer program instructions to cause the apparatus to use a permutation matrix to switch a layer in the set of parent layers to be a parent layer for the tree search, wherein elements of the permutation matrix have a value of zero or one, pre or post multiplication of the permutation matrix by a transpose of the permutation matrix yields an identity matrix, and the permutation matrix is configured to switch a layer in the set of parent layers to be the parent layer and to leave the remaining layers unchanged.

12. The apparatus of claim 1, wherein the processor being configured to select the set of parent layers from the plurality of transmitted layers comprises the processor being configured to execute computer program instructions to further cause the apparatus to select the set of parent layers based on an amount of energy or a channel capacity of each layer in the plurality of transmitted layers.

13. The apparatus of claim 1, wherein the processor is further configured to execute the computer program instructions to cause the apparatus to determine the shortened channel correlation matrix for a second layer in the set of parent layers based on computation results obtained from determining the shortened channel correlation matrix for a first layer in the set of parent layers.

14. A method for detecting data in a wireless communication system, the method comprising:
receiving a digital communication signal, the digital communication signal comprising a plurality of transmitted layers;
determining an estimated channel matrix based on the digital communication signal;
determining a first estimated transmitted symbol vector and a mean square error matrix based on a linear analysis of the received digital communication signal;
determining a first set of bit log likelihood ratios by performing linear minimum mean square error detection based on the first estimated transmitted symbol vector;
determining a second set of bit log likelihood ratios by performing a tree search for one or more layers in the plurality of transmitted layers in the digital communication signal, based on the first estimated transmitted symbol vector and the mean square error matrix;
determining a refined set of bit log likelihood ratios based on the first set of bit log likelihood ratios and the second set of bit log likelihood ratios; and
determining a second estimated transmitted symbol vector based on the refined set of bit log likelihood ratios, wherein the tree search comprises:
selecting a set of parent layers from the plurality of transmitted layers, wherein a number of layers in the set of parent layers is less than or equal to a number of layers in the plurality of transmitted layers;
determining a shortened channel correlation matrix for each layer in the set of parent layers, based on the mean square error matrix;
determining an optimal shortened channel matrix, based on each determined shortened channel correlation matrix and the estimated channel matrix; and
selecting a single child node for each parent node in the tree search based on evaluation of a branch metric.

15. A computer program for detecting data in a wireless communication system, the computer program comprising a non-transitory computer program storage medium comprising instructions that when executed by a processor cause the processor to:
receive a digital communication signal, the digital communication signal comprising a plurality of transmitted layers;
determine an estimated channel matrix based on the digital communication signal;
determine a first estimated transmitted symbol vector and a mean square error matrix based on a linear analysis of the received digital communication signal;
determine a first set of bit log likelihood ratios by performing linear minimum mean square error detection based on the first estimated transmitted symbol vector;
determine a second set of bit log likelihood ratios by performing a tree search for one or more layers in the plurality of transmitted layers in the digital communication signal, based on the first estimated transmitted symbol vector and the mean square error matrix;
determine a refined set of bit log likelihood ratios based on the first set of bit log likelihood ratios and the second set of bit log likelihood ratios; and
determine a second estimated transmitted symbol vector based on the refined set of bit log likelihood ratios, wherein the tree search comprises instructions that when executed by a processor cause the processor to:
select a set of parent layers from the plurality of transmitted layers, wherein a number of layers in the set of parent layers is less than or equal to a number of layers in the plurality of transmitted layers;
determine a shortened channel correlation matrix for each layer in the set of parent layers, based on the mean square error matrix;
determine an optimal shortened channel matrix, based on each determined shortened channel correlation matrix and the estimated channel matrix; and
select a single child node for each parent node in the tree search based on evaluation of a branch metric.
